(19) United States
(12) Patent Application Publication
(10) Pub. No.: US 2006/0285056 A1
(43) Pub. Date: Dec. 21, 2006

(54) Wide viewing angle liquid crystal display and the method for achieving wide viewing angle effect

(76) Inventors: Shie-Chang Jeng, Ligang Township (TW); Kang-Hung Liu, Longtan Township (TW); Chi-Chang Liao, Tainan City (TW); Ku-Hsien Chang, Renwu Township (TW)

Correspondence Address: LIN & ASSOCIATES INTELLECTUAL PROPERTY, P.O. BOX 2339, SARATOGA, CA, 95070-0339, US

(21) Appl. No.: 11/201,840

(22) Filed: Aug. 11, 2005

(30) Foreign Application Priority Data
Jun. 21, 2005 (TW) 094120616

(51) Int. Cl. G02F 1/1339

(52) U.S. Cl. 349/155

(57) ABSTRACT

A wide viewing angle liquid crystal display is provided. It changes the contents of spacers to produce non-homogeneous and symmetric electrical field by embedding conducting particles in the spacers. The liquid crystal display device includes a first substrate, a second substrate, optical films, electrodes, alignment layers and a liquid crystal layer sandwiched by the first and the second substrates. The space between the two substrates further includes plural spacers, where conducting particles are embedded in the spacers. The conducting particles can be embedded directly inside the commercial spacers. The spacers with embedded conducting particles can also be formed by adding a certain ratio of conducting particles in the spacer material during manufacture process. Properly allocating the spacers can optimize the wide viewing angle effect.

### FIELD OF THE INVENTION

The present invention generally relates to a liquid crystal display, and more specifically to a wide viewing angle liquid crystal display (LCD) and a method for achieving wide viewing angle effect.

### BACKGROUND OF THE INVENTION

The liquid crystal displays are gaining popularity as the price decreases. The ongoing research of various LCD technologies has greatly improved the quality of the LCD. Conventional LCD suffers the drawbacks of narrow viewing angle; therefore, many recent research efforts are devoted to the provision of wide viewing angle LCDs. In addition to the use of an external compensation film to improve the light leakage at the dark state, various improvements, such as multi-domain vertical alignment (MVA), in-plane switching (IPS), and fringe field switching (FFS), are proposed and implemented to increase the viewing angle in the bright state when electrical field is applied.

In more recent designs for wide viewing angle, multiple lithographic process must be applied to manufacture the protrusion structure or patterned electrodes so that the liquid crystal will be slantwise aligned and have optical symmetry to improve the viewing angle, as shown in FIG. 1 and FIG. 2.

FIG. 1 shows a schematic view of a structure of a conventional MVA LCD. This type of LCD uses the protrusion structure, or called bumps, of two substrates 101, 102 to form the pre-tilted effect of liquid crystal 104. By further exploiting the characteristic that the dielectric coefficient of the bump material is less than that of the liquid crystal, the improvement of the wide viewing angle can be achieved by such MVA design. In the MVA design, the bump spacing must be less than 30um, therefore the LCD have a low aperture ratio.

FIG. 2 shows a schematic view of another structure of a conventional MVA LCD. This type of LCD forms patterned indium tin oxide (ITO) electrode 201 on two substrates 101, 102 in a cross opposite arrangement. By using a fringe electrical field 202 to drive the tilted direction of the liquid crystal, the MVA manufacture process is simplified. The chiral reagent could be also added to improve the light penetration.

In 1999, the MVA technologies only used bumps on the upper substrate and ITO etching on the lower substrate. The process was simple and the aperture ratio is high. After that, an improved process, based on the color filter film manufacture process, was developed to include the RGB superimposing for spacer design. The improved process was simpler and the contrast is increased.

Furthermore, a technology called superimposed spacing wall bump (SSWB) was developed to provide even brighter wide viewing angle LCD. Using two surrounding wall bumps (SWB) superimposed, the liquid crystal cell gaps are formed to replace the spacers and the disclination line defects of MVA can be controlled. This technology requires neither alignment process, nor spreading spacers. It does not increase the number of masks during the lithographic process, and can achieve good optical performance.

### SUMMARY OF THE INVENTION

The present invention has been made to overcome the above-mentioned drawback of conventional technology using multiple lithography process to achieve the wide viewing angle. The primary object of the present invention is to provide a wide viewing angle LCD by changing the contents of spacers to produce non-homogeneous and symmetric electrical field, where conducting particles are imbedded in spacers.

According to the present invention, the main feature of the wide viewing angle LCD of the present invention is the spacers between the two substrates and the contents of the spacers. A plurality of spread spacers, conducting particles embedded in the spacers, and a liquid crystal layer are placed between the two substrates. The liquid crystal display further comprises of optical films on the outside surface of the substrate, electrode layers and alignment layers on the inside surface of the substrate.

In the preferred embodiments of the present invention, the spread spacers can be the commercial ball spacers or can be manufactured during the display manufacture process. The conducting particles embedded in the spacers can be solid conducting material, or a transparent material coated with a conducting layer.

In the manufacture process, the conducting particles can be embedded directly inside the commercial spacers. The spacers with embedded conducting particles can also be formed by adding a certain ratio of conducting particles in the spacer material during manufacture process of spacers, such as lithography, printing, or molding. Properly allocating the spacers can optimize the wide viewing angle effects.

The wide viewing angle LCD of the present invention does not require additional manufacture process; therefore, the process is simple, the cost is low and the yield rate is high.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of a structure of a conventional MVA LCD.

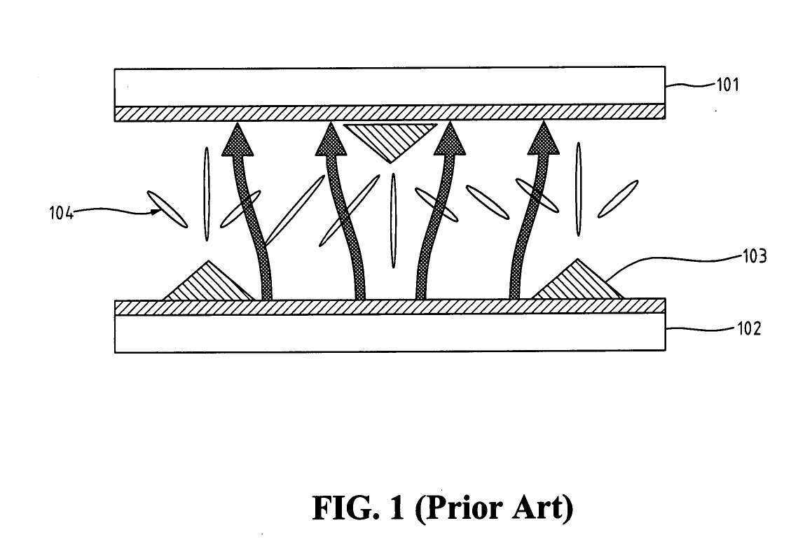

FIG. 2 shows a schematic view of another structure of a conventional MVA LCD.

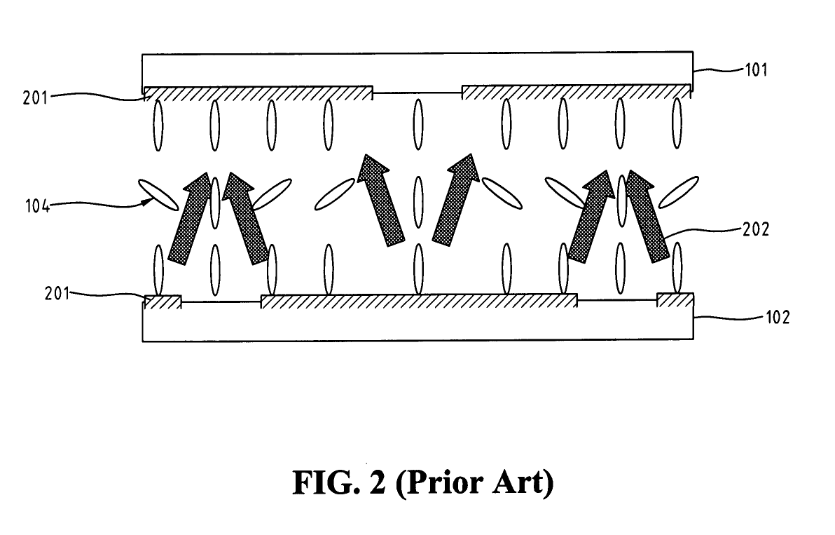

FIG. 3 shows a schematic view of a structure of the present invention.

FIG. 4 shows an embodiment of using ball spacers in FIG. 3.

FIG. 5 shows an embodiment of manufacturing spacers during the manufacture process in FIG. 3.

### DETAILED DESCRIPTION OF THE PREFERRED EMBODIMENTS

As aforementioned, the wide viewing angle LCD of the present invention comprises two substrate, optical films on the outside surfaces of the substrates, electrode layers and alignment layers on the inside surfaces of the substrates. The main feature of the present invention includes the changing of the spacers and the contents of the spacers between the two substrates to produce non-homogeneous and symmetric electrical field to achieve the wide viewing angle effects.

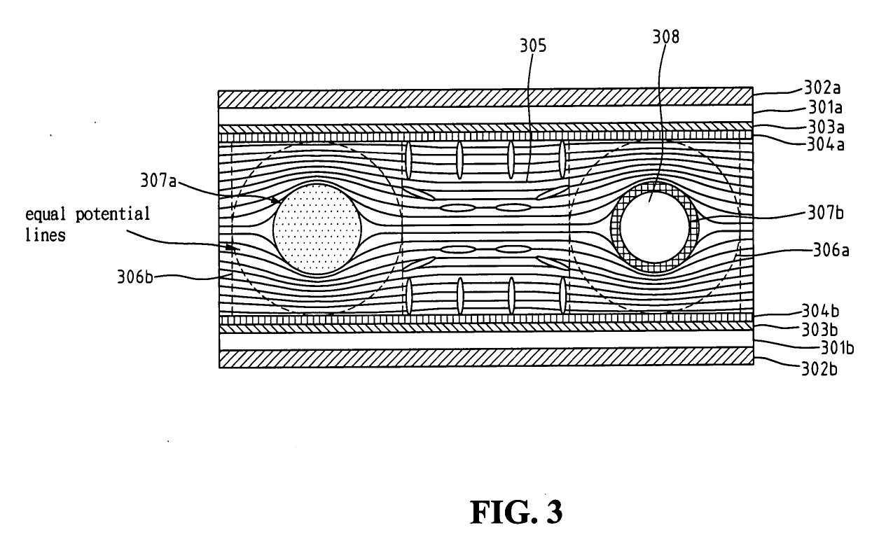

Without loss of the generality, FIG. 3 shows a vertically aligned LCD, including an upper substrate 301a, a lower substrate 301b, two optical films 302a, 302b attached on the outside surface of the substrates, two electrode layers 303a, 303b and two alignment layers 304a, 304b attached on the inside surface of the substrates, a liquid crystal layer 305, and spacers.

As shown in FIG. 3, a plurality of spacers 306a, 306b, conducting particles 307a, 307b embedded in the spacers, and a liquid crystal layer 305 are placed between substrates 301a-301b.

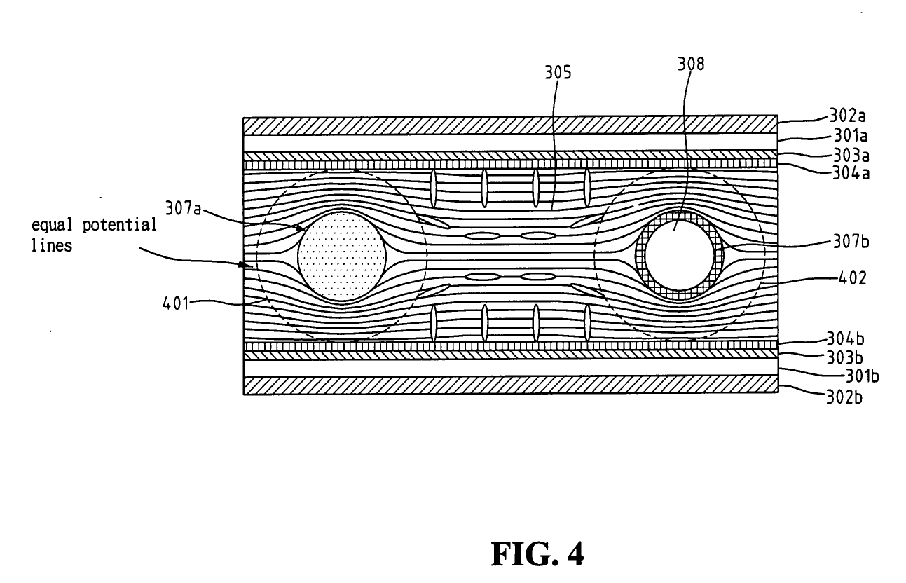

It is worth mentioning, that the plurality of spacers can be either commercial ball spacers 306a, or spacers 306b formed during the manufacture process. The conducting particles embedded in the spacers can be either solid conducting material 307a, or transparent material 308 coated with a conducting layer 307b. FIG. 4 shows an embodiment of FIG. 3, where the spacers are the ball spacers. In this embodiment, the conducting particle embedded in ball spacer 401 is made of solid conducting material, while the conducting particle embedded in ball spacer 402 is made of transparent material 308 coated with a conducting layer 307b.

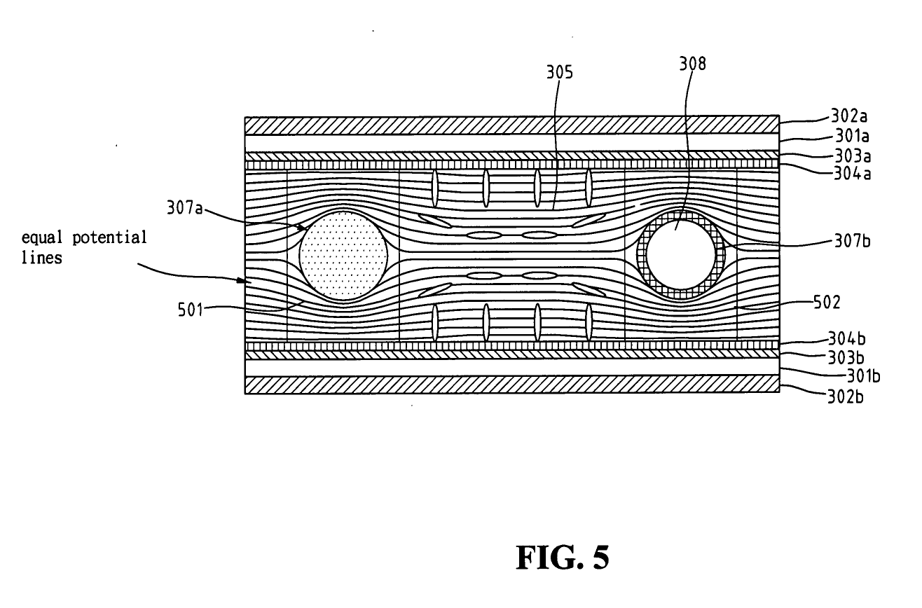

FIG. 5 shows an embodiment of FIG. 3 by forming spacers during the manufacture process. In this embodiment, the conducting particle embedded in spacer 501 is made of solid conducting material, while the conducting particle embedded in spacer 502 is made of transparent material 308 coated with a conducting layer 307b. The methods of forming spacers include lithography, printing, and molding. By adding appropriate ratio of conducting particles into the spacer material, a non-homogeneous and symmetric electrical field can be produced to achieve wide viewing angle effect.

In the aforementioned embodiments, the size of conducting particles must be smaller than cell gap that of the liquid crystal space to avoid short circuit between the upper substrate and the lower substrate. More than a conducting particle can be included in a spacer, as long as the number of the particles will not be large enough to cause the short circuit between the substrates.

The existence of conducting particles causes the electrical field between the substrates to be non-homogeneous and symmetric. Therefore, the n-type liquid crystal will be aligned along the equal potential lines when the external driving voltage exists, which leads to the optical symmetry and improvement of wide viewing angle effect. It is worth noticing that in the simulation of the equal potential lines, the effect on the field distribution caused by the dielectric constant of the spacers and liquid crystal is ignored.

The forming of the aforementioned spacers and the contents can be either by spreading the spacers with embedded conducting particles, or adding a certain ratio of conducting particles to the spacer material during making the spacers in the manufacture process to achieve the non-homogeneous and symmetric electrical field for wide viewing angle effect. As no additional manufacture processes are required, the present invention can be easily manufactured at a low cost with a high yield rate. Properly allocating the spacers can optimize the wide viewing angle effect. The methods of forming spacers during the manufacture process include lithography, printing, and molding.

In summary, the present invention changes the contents of the spacers in the conventional LCD. By embedding conducting particles in the spacers to produce the non-homogeneous and symmetric electrical field to achieve wide viewing angle effects and avoid the need of using multiple lithographic processes. Properly allocating the spacers can optimize the wide viewing angle effect.

Although the present invention has been described with reference to the embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wide viewing angle liquid crystal display (LCD) includes an upper substrate, a lower substrate, optical films on the outside of substrates, two electrode layers and alignment layers on the inside of substrates, between said upper substrate and said lower substrate comprising:
a plurality of spacers;
a plurality of conducting particles, embedded in said spacers; and
a liquid crystal layer.

2. The LCD as claimed in claim 1, wherein said spacers are ball spacers.

3. The LCD as claimed in claim 1, wherein said spacers are formed during the manufacture process of said LCD.

4. The LCD as claimed in claim 1, wherein said conducting particles are made of solid conducting material.

5. The LCD as claimed in claim 1, wherein said conducting particles are made of transparent material coated with a conducting layer.

6. The LCD as claimed in claim 1, wherein said LCD is a vertically aligned LCD.

7. The LCD as claimed in claim 1, wherein said spread spacers are arranged to achieve an optimization of wide viewing angle.

8. A method for achieving wide viewing angle in an LCD, by embedding at least a conducting particles in spacers used in said LCD to produce non-homogeneous and symmetric electrical field.

9. The method as claimed in claim 8, wherein said conducting particles are directly formed in said spacers.

10. The method as claimed in claim 8, wherein said conducting particles are formed during the manufacturing of said spacers by adding an appropriate ratio of said conducting particles into the material for said spacers.

11. The method as claimed in claim 10, wherein said spacers are formed during the manufacture process of said LCD.

12. The method as claimed in claim 11, wherein said spacers are formed by a process chosen from lithography, printing, and molding.
